(19) United States
(12) Patent Application Publication
(10) Pub. No.: US 2016/0341444 A1
(43) Pub. Date: Nov. 24, 2016

(54) GRILL GRATE HEAT EXCHANGER

(71) Applicant: Darcy McMenamin, (US)

(72) Inventor: Darcy McMenamin, Holbrook, MA (US)

(21) Appl. No.: 15/160,086

(22) Filed: May 20, 2016

Related U.S. Application Data
(60) Provisional application No. 62/165,175, filed on May 21, 2015.

(51) Int. Cl. F24H 1/00; A47J 37/06

(52) U.S. Cl. CPC F24H 1/0072; A47J 37/06

(57) ABSTRACT

A grill is provided for comprising a grill grate with a heat exchanger disposed within the grill grate that is designed to allow a liquid to flow through the heat exchanger through the use of a pump and a temperature sensor. The pump is configured to decrease the flow rate of the liquid when the temperature of the liquid drops below a pre-determined temperature and to increase the flow rate of the liquid when the temperature of the liquid rises above a predetermined temperature.

### RELATED APPLICATIONS

This application claims the benefit of U.S. Provisional Patent Application No. 62/165,175, which was filed on May 21, 2015 and titled “Grill Grate Heat Exchanger” by Darcy McMenamin, the disclosure of which is hereby incorporated by reference.

### FIELD

This disclosure relates to a grate for a commercial grill that includes a heat exchanger for capturing excess grill heat and using it to heat liquids. The hot liquids from the heat exchanger may be used to pre-heat water for a boiler, stored in a hot water tank, or may be used directly in a forced hot water heating system.

### BACKGROUND

Embodiments of this disclosure relate to systems, methods, and apparatuses for capturing excess, wasted heat from a commercial grill and reusing that excess heat to provide hot water. Commercial kitchens, such as in restaurants and cafeterias commonly use a grill, among several other industrial-grade cooking apparatuses. Under typical conditions, industrial grills burn a fuel source, such as propane or charcoal, beneath a metal grate in order to heat the grate for cooking. When food items are placed upon the hot grate, some portion of the heat generated by the expended fuel is absorbed by the food item, which becomes heated and, eventually cooked. However, the vast majority of heat generated by the grill escapes in the form of hot air that may be vented by a hood above the grill and eventually discharged outside the kitchen facility.

Some commercial kitchens have attempted to recapture some of the wasted heat from a grill by mounting a heat exchanger within the grease filters in the hoods above the grill. Baffle-type grease filters are commonly known within the commercial kitchen industry as a technique for removing and separating entrained grease from a flow of air, typically in an exhaust hood, extractor hood, or range hood. Such filters remove airborne grease, combustion products, fumes, smoke, odors, heat, and steam from the air by evacuation of the air and filtration. Baffle filters force the air to move through a series of baffles, forcing it into a series of 180-degree turns, causing the grease to be deposited in the bends of the baffles. Some kitchens have also installed heat exchangers within these baffle-type grease filters in order to recapture some of the excess heat generated by the grill before venting it outside the kitchen facility. However, such devices do not recapture a significant amount of heat energy from the ambient air and typically only recapture only a fraction of wasted heat energy.

### SUMMARY

Embodiments of the disclosure relate to systems, methods, and apparatuses for heating liquids through the use of a heat exchanger in a grill. In one embodiment, a grill comprises a grill grate that includes a heat exchanger disposed within said grill grate designed to allow a liquid to flow through said heat exchanger. The heat exchanger is attached to a pump and a temperature sensor. The pump may also be configured to decrease the flow rate of the liquid when the temperature of the liquid drops below a pre-determined temperature and further configured to increase the flow rate of the liquid when the temperature of the liquid rises above a predetermined temperature.

In some embodiments, the grill grate is comprised of steel, stainless steel, carbon steel, iron, cast iron, porcelain and/or aluminum. In other embodiments, the heat exchanger is comprised of steel, stainless steel, carbon steel, iron, cast iron, copper, brass, and/or aluminum. The pump may be configured to accelerate if the temperature of the liquid from the heat exchanger is detected as being between 120°−200° and to decelerate if the temperature of the liquid from the heat exchanger is detected as being between 80°−190°. In some embodiments, the pump is connected to a fryalator in order to pass oil through said heat exchanger or to a hot water tank in order to pass water through said heat exchanger. In other embodiments, the pump may be connected to a boiler in order to pre-heat water for the boiler. In other embodiments, the pump may be connected to a forced hot water heating system. Finally, the grill may further comprising an emergency shutoff valve that is configured to stop any additional liquid from entering the heat exchanger when the temperature of the liquid exceeds a pre-determined temperature and the pump may be further configured to flush all liquid from the heat exchanger when the temperature of the liquid exceeds a pre-determined temperature.

An alternative embodiment comprises a grill with a grill grate heat exchanger, including one or more header tubes, one or more grill tubes, and one or more liquid supply adapters; such that said grill grate heat exchanger allows a liquid to flow through the one or more liquid supply adapters, said one or more header tubes, and said one or more grill tubes. The grill grate heat exchanger is attached to a pump and a temperature sensor, wherein the pump is configured to decrease the flow rate of the liquid when the temperature of the liquid drops below a pre-determined temperature and further configured to increase the flow rate of the liquid when the temperature of the liquid rises above a predetermined temperature.

In some embodiments, the grill grate heat exchanger, the header tubes, the grill tubes, may be comprised of steel, stainless steel, carbon steel, iron, cast iron, porcelain and/or aluminum. In other embodiments, the pump may be configured to accelerate if the temperature of the liquid from the grill grate heat exchanger is detected as being between 120°−200° and decelerate if the temperature of the liquid from the grill grate heat exchanger is detected as being between 80°−190°. In some embodiments, the pump may be connected to a fryalator in order to pass oil through said grill grate heat exchanger, or it may be connected to a hot water tank in order to pass water through said grill grate heat exchanger, or it may be connected to a boiler in order to pre-heat water for said boiler, or it may be connected to a forced hot water heating system. In other embodiments, the grill may further comprising an emergency shutoff valve that is configured to stop any additional liquid from entering said grill grate heat exchanger and the pump may be configured to flush all liquid from the heat exchanger when the temperature of the liquid exceeds a pre-determined temperature.

### BRIEF DESCRIPTION OF THE DRAWINGS

Various aspects of at least one embodiment are discussed below with reference to the accompanying figures. The figures are provided for the purposes of illustration and explanation and are not intended as a definition of the limits of the invention. In the figures:

FIG. 1 is a front perspective view of the exterior of a grill according to one embodiment.

FIG. 2 is a front perspective view of a grill according to an embodiment, showing the internal heat exchanger components.

FIG. 3 is a cross sectional view of a section of a grill grate with an internal heat exchanger according to an embodiment.

FIG. 4 is an exploded cross-sectional view of a grill grate with an internal heat exchanger according to an embodiment.

FIG. 5. is a schematic view of a grill according to an embodiment, connected to a hot water tank, furnace, and forced hot water heating system.

FIG. 6 is side, top, rear, and top perspective views of a grill grate heat exchanger according to an embodiment.

### LIST OF REFERENCE NUMERALS UTILIZED IN THE DRAWINGS

With regard to reference numerals used, the following numbering is used throughout the description and drawings. Where technical features in the figures or detailed description are followed by these reference numerals, the reference numerals have been included for the sole purpose of increasing the intelligibility of the figures or detailed description. Accordingly, neither the reference numerals nor their absence are intended to have any limiting effect on the scope of any claim elements. In the figures, each identical or nearly identical component that is illustrated in various figures is represented by a like numeral. For purposes of clarity, not every component may be labeled in every figure.
Reference numeral 1 refers to a grill grate.
Reference numeral 2 refers to a grill housing.
Reference numeral 3 refers to a grill leg.
Reference numeral 4 refers to knobs.
Reference numeral 5 refers to burners.
Reference numeral 6 a fuel supply.
Reference numeral 7 refers to a heat exchanger.
Reference numeral 8 refers to a distal end of a grill.
Reference numeral 9 refers to a proximal end of a grill.
Reference numeral 10 refers to a pump.
Reference numeral 11 refers to a temperature sensor.
Reference numeral 12 refers to a wire.
Reference numeral 13 refers to a hot water supply.
Reference numeral 14 refers to a top portion of a grill grate.
Reference numeral 15 refers to a bottom portion of a grill grate.
Reference numeral 16 refers to a cold water supply.
Reference numeral 17 refers to a hot water tank.
Reference numeral 18 refers to a baseboard heating unit.
Reference numeral 19 refers to a furnace or boiler.
Reference numeral 20 refers to a distal header assembly.
Reference numeral 21 refers to a proximal header assembly.
Reference numeral 22 refers to one or more bores.
Reference numeral 23 refers to one or more tubes.
Reference numeral 24 refers to a riser tubes.
Reference numeral 25 refers to a pipe thread adapter.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as may be included within the spirit and scope of the described embodiments as defined by the appended claims.

As disclosed herein, the devices and methods presented can be used for a grate for a grill in a commercial kitchen having an internal heat exchanger for capturing excess heat and using it to heat water.

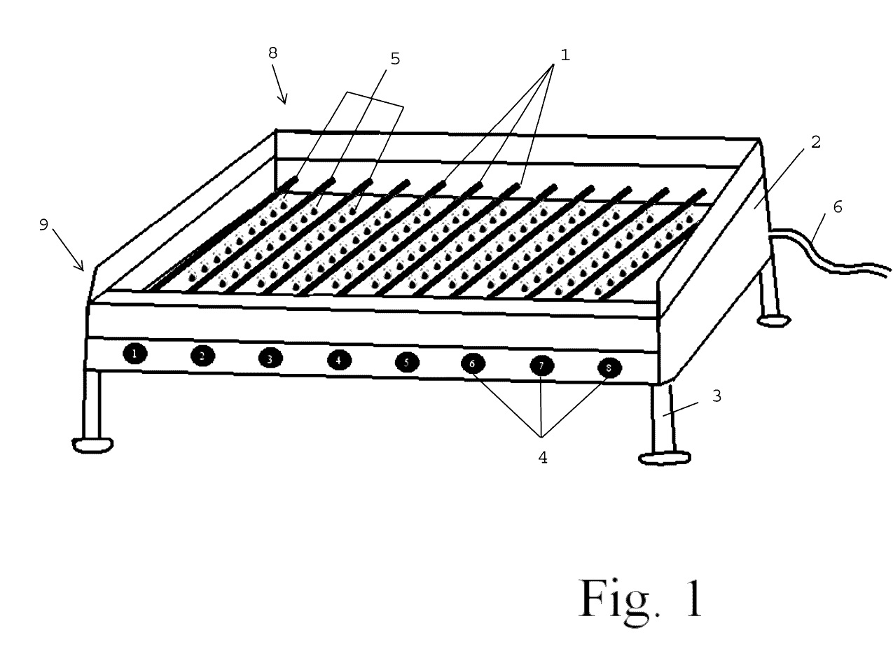

FIG. 1 shows an external view of a grill according to an exemplary embodiment. As shown, for example, in FIG. 1, a grill according to an embodiment may appear, from the outside, similar to a typical grill in a commercial kitchen. A grill according to an embodiment may include a grate 1, which may be formed of any suitably conductive metal material, such as steel, stainless steel, cast iron, or porcelain. However, one of ordinary skill in the art would recognize that these are just a few examples of suitable materials for grate 1. In some embodiments, grate 1, may be formed into a series of parallel metal bars, having a circular, square, or rectangular cross section. Alternatively, a metal mesh grate 1 may be used, so long as grate 1 may include a hollow, internal portion for receiving a heat exchanger.

Additionally, a grill according to an embodiment may include additional components of an industrial grill. For example, grill grate 1, may be disposed within a grill housing 2, which may comprise a metal base, side walls, and a back wall. Grill housing 2, may be supported by legs 3, which may be fixed or attached at the corners of grill housing 2 and support grill housing 2. A plurality of control knobs 4 may be located on the front face of grill housing 2 and may be used to control the flow of fuel to burners 5, as is known to one of ordinary skill in the art. Additionally, a grill according to an embodiment may also include a fuel supply source 6, which may comprise a propane hose, in some embodiments, as shown for example, in FIG. 1.

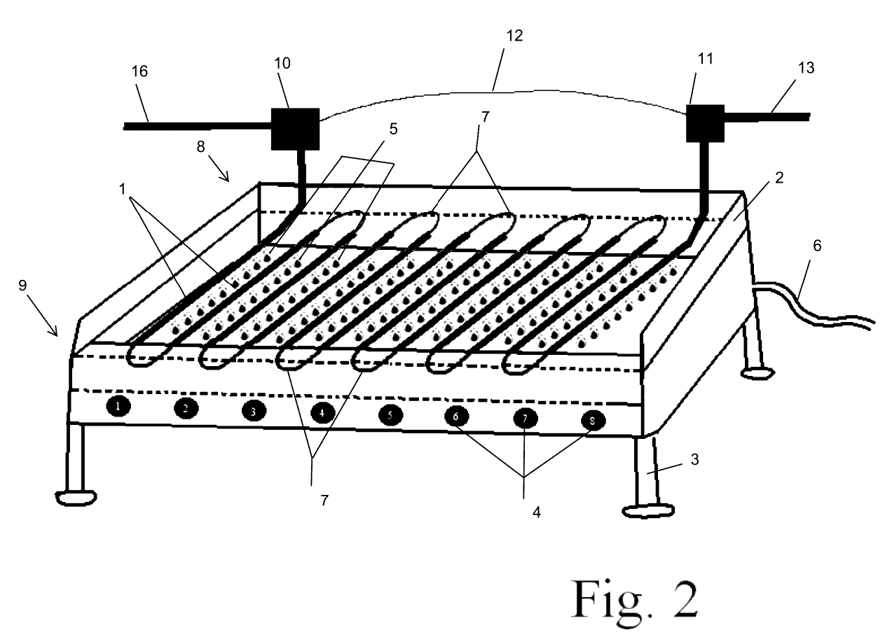

FIG. 2, shows a transparent front perspective view of a grill according to an exemplary embodiment, showing the internal components of the grill. As shown, for example, in FIG. 2, the grill may further include a heat exchanger 7 that is disposed within and throughout grill grate 1. In some embodiments, heat exchanger 7 may comprise a flexible, conductive metal tubing, which may be formed of metals such as copper, titanium, nickel, stainless steel, steel, carbon steel, or brass. However, one of ordinary skill in the art will appreciate that several other materials may be employed for use in heat exchanger 7. As shown, for example, in FIG. 2, heat exchanger 7 may be embedded within grill grate 1, such that it enters the distal end 8 of a first length of grill grate 1 and exits a proximal end 9 of the first length of grill grate 1. Heat exchanger 7 then bends and re-enters the proximal end of grill grate 1 at a second length of grill grate 1. As shown, for example in FIG. 2, heat exchanger 7 may be disposed throughout grill grate 1 in this manner such that heat exchanger 7 may comprise a single, unbroken length of metal tubing.

In some embodiments, heat exchanger 7 may be substantially filled with water for capturing, storing, transporting, and reusing excess heat from the grill. However, one of ordinary skill in the art will appreciate that other liquid media may be used for capturing, storing, transporting, and reusing heat from grill grate 1. For example, in some embodiments, cooking oil from a fryalator may be passed through heat exchanger 7 in order to heat the oil for cooking in the fryalator. When the invention is configured to heat water, water may be passed through heat exchanger 7 by pump 10. Pump 10 may be connected to cold water supply line 16 and heat exchanger 7. Pump 10 may be further coupled to temperature sensor 11 by wire 12. In some embodiments, Pump 10 may be configured to increase the water flow rate through heat exchanger 7 when the temperature of sensor 11 exceeds a first pre-defined temperature. Pump 10 may also be configured to reduce water flow rate through heat exchanger 7 when sensor 11 indicates that the temperature of the water has dropped below a second pre-defined temperature. By alternatively increasing and decreasing the water flow rate, heat exchanger 7 may be configured to supply water at a pre-defined temperature range through hot water supply 13. In some embodiments, heat exchanger 7 may be configured to supply water with a temperature as high, at times, as ° 400 F. Likewise, by regulating the flow rate of the cold water supply, the kitchen staff does not need to adjust their cooking procedures in order to supply a desired amount of heat to heat exchanger 7, but may instead continue use the grill as they normally would.

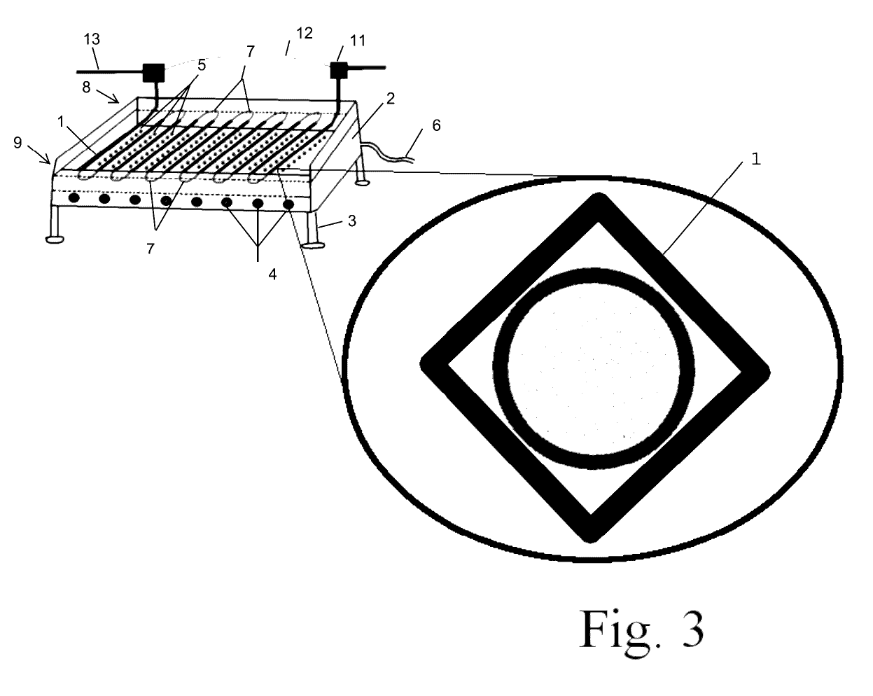

FIG. 3 shows a cross sectional view of grill grate 1 and heat exchanger 7 according to one embodiment. In this example embodiment, grill grate 1 comprises a series of parallel lengths of cast iron, formed into a square or diamond cross-sectional shape. The metal lengths of grill grate 1 may comprise thickness of approximately 0.2-2 inches in diameter, but any thickness will be suitable, so long as grill grate 1 is thick enough to accommodate a bore throughout its length so as to accommodate heat exchanger 7. As shown in FIG. 3, heat exchanger 7 may comprise a length of flexible, conductive metal tubing, such as copper, for example, that is disposed within the hollow portion of grill grate 1. Heat exchanger 7 may be substantially filled with water or another suitable liquid during use, as shown for example in FIG. 0.3.

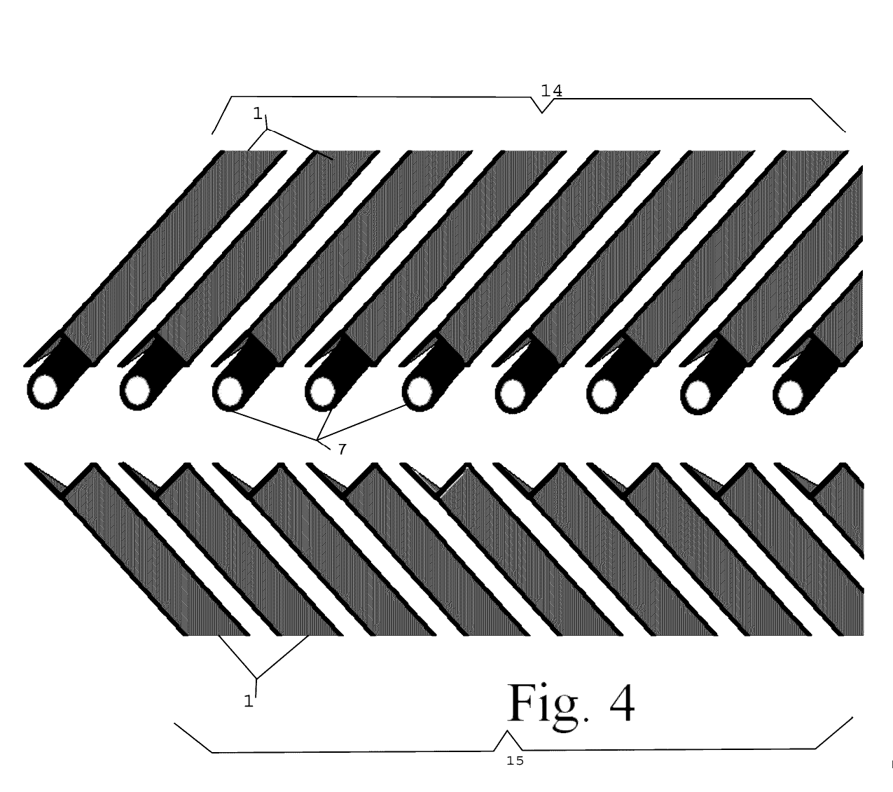

FIG. 4 shows another embodiment wherein grill grate 1 may comprise an upper portion 14 and a lower portion 15. For example, in FIG. 4, upper portion 14 grill grate 1 comprises a series of parallel lengths of conductive metal material that is formed into the cross-sectional shape of a chevron along its length. Likewise, lower portion 15 of grill grate 1 may comprise similar lengths of conductive metal material that have a cross-sectional chevron shape, but points downward. In such embodiments, upper portion 14 and 15 may attach to one another so as to form a grill grate 1 with a substantially hollow interior and a square or diamond-shaped cross section. Upper portion 14 and lower portion 15 may be attached to one another using any suitable means known to those of ordinary skill in the art, including locking, screwing, welding, and/or soldering.

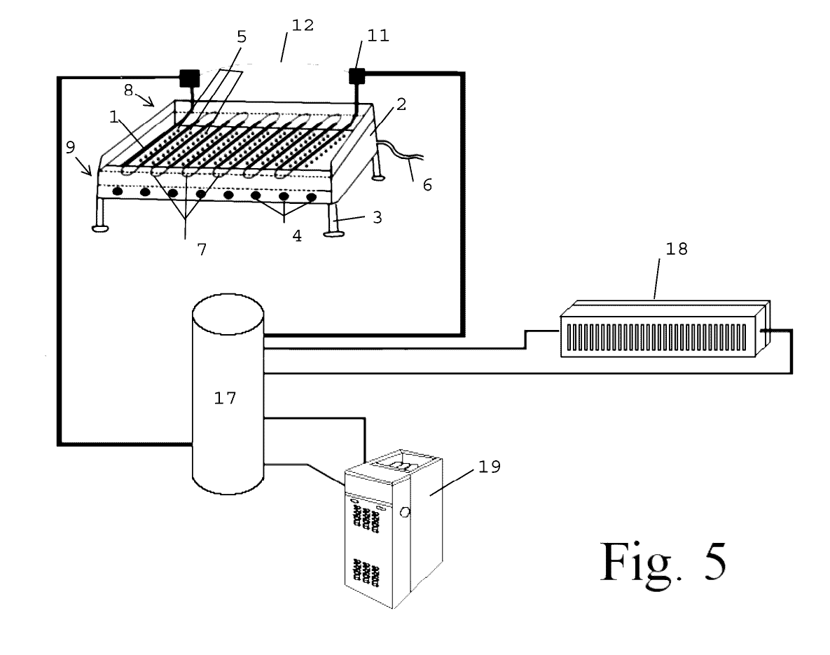

FIG. 5 shows a schematic of an embodiment, as it may be used within a commercial kitchen. Embodiments may be configured to work together with a facility heating system in order to supplement the energy used to heat water in connection with the heating system. For example, in one embodiment, cold water supply line 16 may be drawn from hot water tank 17, via pump 10. Pump 10 may then force the cold water through heat exchanger 7, while the grill is in use, so as to capture excess heat from the grill, thereby raising the temperature of the cold water. The now-hot water may then exit heat exchanger 7, pass through temperature sensor 11, and travel through hot water supply 13 back to the hot water storage tank 17. From there, the hot water may be distributed throughout a forced water heating system and, in some embodiments, through baseboard heaters 18. Hot water storage tank 17 may still be connected to furnace/boiler 19, so that storage tank 17 may continue to receive hot water during periods of non-use of the grill or when the heat supplied by the grill is insufficient to meet the heating needs of the facility.

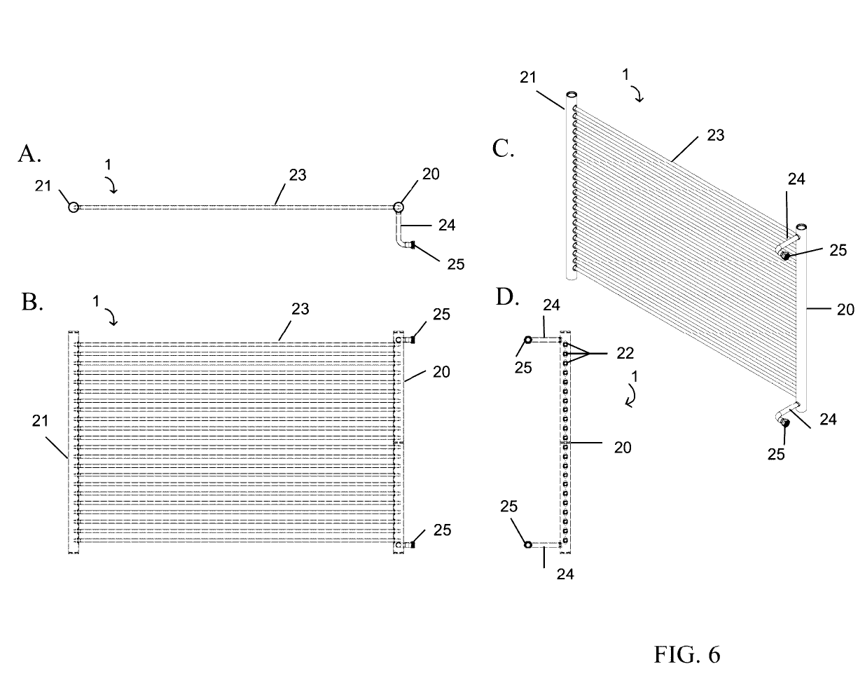

FIG. 6 shows an alternate embodiment of the grill, wherein the grill grate and the heat exchanger comprise a single component and there is no need to dispose a separate heat exchanger within the grill grate. FIG. 6 shows a side view (6A), a top view (6B), a right side view (6C), and a bottom perspective view of the grill grate. In this embodiment, grill grate 1 may serve as both a grill grate and a heat exchanger simultaneously. For example, as shown in FIG. 6, the grill grate 1 may comprise a distal header assembly 20 which is situated on grill grate 1 away at the distal end of grill grate 1, away from the grill operator. Distal header assembly 20, may comprise a length of hollow tubing which may be formed of any material that is suitable for serving as both a grill grate and a heat exchanger including, but not limited to, steel, stainless steel, carbon steel, cast iron, iron, aluminum, copper, and/or brass. However, one of ordinary skill in the art will appreciate that these are just a few examples of suitable materials. Distal header assembly 20 may have an outside diameter ranging from approximately 0.5-4 inches wide. In some embodiments, the outside diameter may be approximately 2.25 inches. In some embodiments, distal header assembly 20 may be capped or closed at both ends, and include a series of evenly space bores 22 along its length. Bores 22 may be threaded or smooth, and in some embodiments, may have an inside diameter between 0.25 and 3 inches. Distal header 20 may be sized and dimensioned to meet the needs of any given grill. However, in some embodiments, distal header 20 may be approximately 24 inches long and include twenty one bores 22.

Distal header 20 may be attached to one or more grill tubes 23 at bores 22. In some embodiments, grill tubes 23 may comprise a hollow tube with an external diameter between 0.25 and 3 inches. Grill tubes 23 may be comprised of any material that is suitable for serving as both a grill grate and a heat exchanger including, but not limited to, steel, stainless steel, carbon steel, cast iron, iron, aluminum, copper, and/or brass. However, one of ordinary skill in the art will appreciate that these are just a few examples of suitable materials. Grill tubes 23 may be fastened to distal header 20 at bores 22 using any suitable means of attachment as are known to those of ordinary skill in the art, including screwing, locking, welding, and/or soldering. Grill tubes 23 may be sized and dimensioned to meet the needs of any given grill. However, in some embodiments, grill tubes 23 may be between 6 inches and 48 inches. In some embodiments, grill tubes 23 may be approximately 34-36 inches long.

Grill tubes 23 connect to distal header to at the distal end of grill tube 23 and proximal header assembly 21 at the proximal end of grill tube 23. Proximal header assembly 21 may have a design and constructed in the same manner as distal header assembly 20 and may be fastened to grill tube 23 in the same manner as described above with respect to distal header assembly 20. Thus, distal header assembly 20, grill tubes 23, and proximal header assembly 21, together form, on the exterior, a typically grilling surface and, on the interior, form a continuous, hollow space for accommodating a liquid and for use as a heat exchanger.

In some embodiments, distal header 20 may also comprise two or more pipe thread adapters 25 for connecting with cold water supply 16 and hot water supply 13. Threaded adapter 25 may comprise any suitable size adapter for use with cold water supply 16 and hot water supply 13, as are known to those of ordinary skill in the art. In some embodiments, one or more of threaded adapters 25 may be connected to proximal header assembly 21 instead of distal header assembly 20. In some embodiments, a riser tube may be disposed between distal header assembly 20 and threaded adapter 25, as shown, for example, in FIG. 6.

While the disclosed subject matter is described herein in terms of certain exemplary embodiments, those skilled in the art will recognize that various modifications and improvements can be made to the disclosed subject matter without departing from the scope thereof. As such, the particular features claimed below and disclosed above can be combined with each other in other manners within the scope of the disclosed subject matter such that the disclosed subject matter should be recognized as also specifically directed to other embodiments having any other possible permutations and combinations. It will be apparent to those skilled in the art that various modifications and variations can be made in the systems and methods of the disclosed subject matter without departing from the spirit or scope of the disclosed subject matter. Thus, it is intended that the disclosed subject matter include modifications and variations that are within the scope of the appended claims and their equivalents.

1. A grill comprising:
a grill grate;
a heat exchanger disposed within said grill grate designed to allow a liquid to flow through said heat exchanger;
wherein said heat exchanger is attached to a pump and a temperature sensor; and
said pump is configured to decrease the flow rate of the liquid when the temperature of the liquid drops below a pre-determined temperature and further configured to increase the flow rate of the liquid when the temperature of the liquid rises above a predetermined temperature.

2. The grill of claim 1 wherein said grill grate is comprised of steel, stainless steel, carbon steel, iron, cast iron, porcelain and/or aluminum.

3. The grill of claim 2 wherein said heat exchanger is comprised of steel, stainless steel, carbon steel, iron, cast iron, copper, brass, and/or aluminum.

4. The grill of claim 3, wherein said pump is configured to accelerate if the temperature of the liquid from the heat exchanger is detected as being between ° 120-° 200.

5. The grill of claim 4, wherein said pump is configured to decelerate if the temperature of the liquid from the heat exchanger is detected as being between °80-°190.

6. The grill of claim 3, wherein said pump is connected to a fryalator in order to pass oil through said heat exchanger.

7. The grill of claim 3, wherein said pump is connected to a hot water tank in order to pass water through said heat exchanger.

8. The grill of claim 3, wherein said pump is connected to a boiler in order to pre-heat water for said boiler.

9. The grill of claim 3, wherein said pump is connected to a forced hot water heating system.

10. The grill of claim 3, configured to provide hot liquids for use in cooking applications.

11. The grill of claim 3 further comprising a lid.

12. The grill of claim 5 further comprising an emergency shutoff valve that is configured to stop any additional liquid from entering said heat exchanger when the temperature of the liquid exceeds a pre-determined temperature.

13. The grill of claim 12 wherein the pump is further configured to flush all liquid from the heat exchanger when the temperature of the liquid exceeds a pre-determined temperature.

14. A grill comprising:
a grill grate heat exchanger with one or more header tubes, one or more grill tubes, and one or more liquid supply adapters; such that said grill grate heat exchanger allows a liquid to flow through said one or more liquid supply adapters, said one or more header tubes, and said one or more grill tubes.

15. The grill of claim 14, wherein said grill grate heat exchanger is attached to a pump and a temperature sensor wherein said pump is configured to decrease the flow rate of the liquid when the temperature of the liquid drops below a pre-determined temperature and further configured to increase the flow rate of the liquid when the temperature of the liquid rises above a predetermined temperature.

16. The grill of claim 15, wherein said grill grate heat exchanger is comprised of steel, stainless steel, carbon steel, iron, cast iron, porcelain and/or aluminum.

17. The grill of claim 16, wherein said one or more header tubes are comprised of steel, stainless steel, carbon steel, iron, cast iron, copper, brass, porcelain and/or aluminum.

18. The grill of claim 17, wherein said one or more grill tubes are comprised of steel, stainless steel, carbon steel, iron, cast iron, copper, brass, porcelain and/or aluminum.

19. The grill of claim 18, wherein said pump is configured to accelerate if the temperature of the liquid from the grill grate heat exchanger is detected as being between ° 120-° 200.

20. The grill of claim 19, wherein said pump is configured to decelerate if the temperature of the liquid from the grill grate heat exchanger is detected as being between °80-°190.

21. The grill of claim 20, wherein said pump is connected to a fryalator in order to pass oil through said grill grate heat exchanger.

22. The grill of claim 21, wherein said pump is connected to a hot water tank in order to pass water through said grill grate heat exchanger.

23. The grill of claim 22, wherein said pump is connected to a boiler in order to pre-heat water for said boiler.

24. The grill of claim 23, wherein said pump is connected to a forced hot water heating system.

25. The grill of claim 24, configured to provide hot liquids for use in cooking applications.

26. The grill of claim 17, further comprising a lid.

27. The grill of claim 20, further comprising an emergency shutoff valve that is configured to stop any additional liquid from entering said grill grate heat exchanger when the temperature of the liquid exceeds a pre-determined temperature.

28. The grill of claim 27, wherein the pump is further configured to flush all liquid from the heat exchanger when the temperature of the liquid exceeds a pre-determined temperature.
